(19) United States
(12) Patent Application Publication
(10) Pub. No.: US 2025/0222665 A1
(43) Pub. Date: Jul. 10, 2025

(54) CORE STRUCTURE PANEL WITH A TRIPLY PERIODIC MINIMAL SURFACE CORE

(71) Applicant: THE BOEING COMPANY, Arlington, VA (US)

(72) Inventors: Dylan Reuel Weber, Hermosa Beach, CA (US); Jay J. Patel, Irvine, CA (US)

(21) Appl. No.: 18/965,495

(22) Filed: Dec. 2, 2024

Related U.S. Application Data
(63) Continuation-in-part of application No. 18/404,574, filed on Jan. 4, 2024.

(51) Int. Cl. B29C 73/06; B32B 3/12; B33Y 80/00

(52) U.S. Cl. CPC B29C 73/06; B32B 3/12; B32B 2250/02; B33Y 80/00

(57) ABSTRACT

A core structure panel includes a first skin and a triply periodic minimal surface (TPMS) core additively manufactured as a unit. The core structure panel also includes a second skin coupled to the TPMS core. The TPMS core is positioned between the first skin and the second skin.

### CROSS-REFERENCE TO RELATED APPLICATIONS

The present application claims priority from and is a continuation-in-part of pending U.S. patent application Ser. No. 18/404,574 entitled “CORE REPAIR OF A CORE STRUCTURE PANEL USING A TRIPLY PERIODIC MINIMAL SURFACE STRUCTURE,” filed Jan. 4, 2024, the content of which is incorporated herein by reference in its entirety.

### FIELD OF THE DISCLOSURE

The present disclosure is generally related to a core structure panel with a triply periodic minimal surface (TPMS) core.

### BACKGROUND

Core structure panels include skins on each side of a low-density core material (e.g., fiberglass, carbon fiber reinforced polymer, nomex aramide paper, aluminum, etc.). The skin materials and the core material are often chosen so the core structure panel has particular properties based on an intended application for the core structure panel. The core material may be chosen based on mechanical properties (e.g., a response in one or more directions to tension loads, compression loads, and shear loads), energy absorption properties, vibration and acoustic properties, thermal insulation properties, other properties, or combinations thereof. Conventional core material is often a cellular structure or a foam. Cellular structures for core structure panels include honeycomb shape structures, diamond shape structures, rectangular shape structures, and corrugated structures. Some core structure panels with conventional core material can have low impact resistance, can be susceptible to failure due to application of load in one or more directions due to an anisotropic nature of the core structure, can be difficult to manufacture due to curvature when the core structure panel is not a flat core structure panel, can be inefficient to manufacture due to material waste during formation of the core structure, or combinations thereof. It is desirable to efficiently produce a core structure panel with high impact resistance and resistance to load failure due to an isotropic, or substantially isotropic, nature of the core structure.

During use of a core structure panel, impact against the core structure panel can cause inconsistencies. For example, a lightning strike can create inconsistencies in one or both skins and the core of the core structure panel. As another example, an object strike against the skin of the core structure panel can crush a portion of the core with or without breaking the skin of the core structure panel. The core may also be susceptible to inconsistencies due to ingress of water or other contaminants through one or more openings in one or both skins of the core structure panel or by diffusion of water or contaminants through one or both of the skins. Inconsistencies in the core can adversely change the mechanical properties of the core structure panel, can cause separation of the core from one or both skins, or both. When a core structure panel has core inconsistencies that are larger than a size that can be repaired using potting compound, the core structure panel can be repaired by removing a portion of the core, replacing removed core with a core plug, and patching removed or damaged skin portions. It is desirable to have a core plug with properties (e.g., mechanical properties and water tolerance) that enable continued use of the core structure panel after the repair.

### SUMMARY

In a particular implementation, a core structure panel includes a first skin and a TPMS core additively manufactured as a unit. The core structure panel also includes a second skin coupled to the TPMS core. The TPMS core is positioned between the first skin and the second skin.

In another particular implementation, a core structure panel includes a first skin, a second skin, and a TPMS core additively manufactured as a unit. The TPMS core is positioned between the first skin and the second skin.

In another particular implementation, a method includes additively manufacturing a first skin of a core structure panel and a TPMS core as a unit. The method also includes coupling a second skin to the TPMS core. The TPMS core is positioned between the first skin and the second skin.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 depicts a perspective representation of a unit cell of a gyroid TPMS structure.

FIG. 2 depicts a perspective representation of a unit cell of a Fischer-Koch S surface TPMS structure.

FIG. 3 depicts a perspective representation of a unit cell of a PMY TPMS structure.

FIG. 4 depicts a perspective representation of a TPMS structure with a density gradient.

FIG. 5A is a cross-sectional representation of a portion of a first implementation of a core structure panel formed as a unit of a first skin and a TPMS core.

FIG. 5B is a cross-sectional representation of the portion of FIG. 5B with a second skin coupled to the core and the first skin to form the core structure panel

FIG. 6 is a cross-sectional representation of a portion of a second implementation of core structure panel with a first skin, a TPMS core, and a second skin.

FIG. 7 is a side view section representation of a portion of a third implementation of a cut open core structure panel with a first skin, a TPMS core, and a second skin.

FIG. 8 is a block diagram of a system to generate a core structure panel with a TPMS core.

FIG. 9 is a flow chart of an example method for manufacturing a core structure panel having a first skin, a second skin, and a TPMS core positioned between the first skin and the second skin.

FIG. 10 depicts a cross-sectional representation of a portion of a core structure panel with a TPMS structure that is a full depth replacement of a portion of a core of the core structure panel.

FIG. 11 depicts an exploded view of a system for repair of a portion of the core structure panel of FIG. 10 prior to placement of components of a repair patch used to repair the core structure panel in, or on, the core structure panel.

FIG. 12 depicts a cross-sectional representation of a portion of a core structure panel with a TPMS structure that is a partial depth replacement of a portion of a core of the core structure panel.

FIG. 13 is a block diagram representation of a system to repair a core structure panel.

FIG. 14 is a flow chart of an example method for repairing a core structure panel with a repair patch.

### DETAILED DESCRIPTION

Aspects disclosed herein present systems and methods for forming a core structure panel that includes a first skin and a core additively manufactured as a unit, and a second skin coupled to the core. In some implementations, the second skin is bonded to the core. In other implementations, the first skin, the core, and the second skin are additively manufactured as a single piece. The core is a TPMS structure and is positioned between the first skin and the second skin.

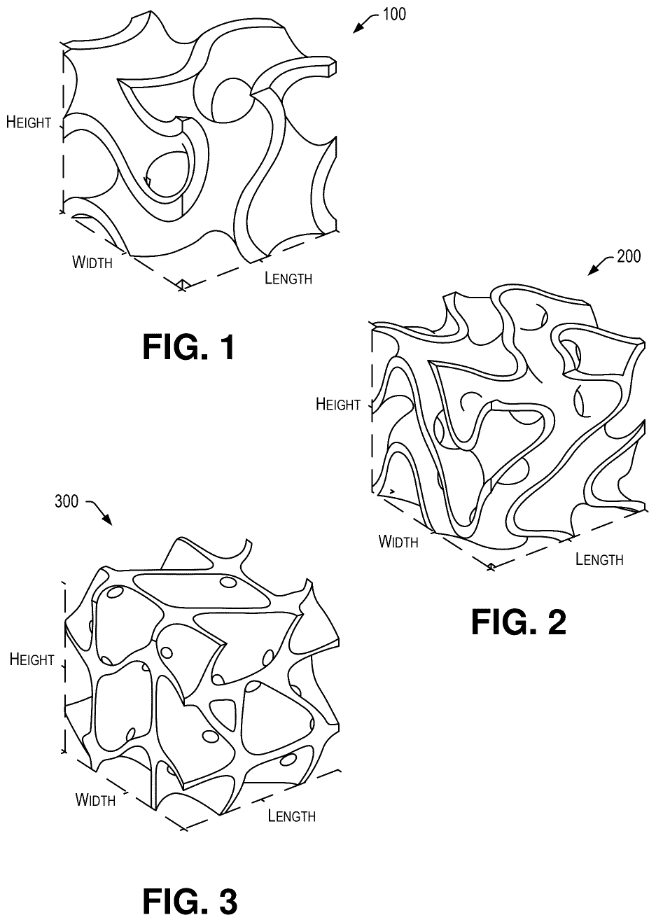

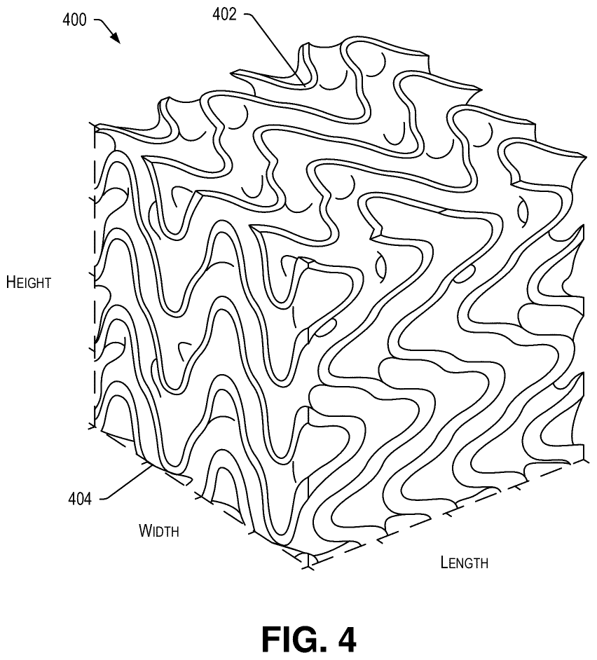

A TPMS structure has a minimal surface (i.e., a sum of principal curvatures at each point of a surface is, or is close to, zero so that there is substantially zero mean curvature) that repeats in three dimensions. FIGS. 1-3 depict perspective representations of unit cells of three types of TPMS structures. Height, width, and length axes are not physically present and so are depicted as broken lines in FIGS. 1-3. FIG. 1 depicts a TPMS structure 100 with a gyroid lattice structure, FIG. 2 depicts a TPMS structure 200 with a Fischer-Koch S surface lattice structure, and FIG. 3 depicts a TPMS structure 300 with a PMY lattice structure. Other types of TPMS structures may also be used as the core of a core structure panel or as part of a core repair plug for a damaged core structure panel. The TPMS structures can have uniform density in all directions, or the TPMS structures may be graded so that there is a density gradient in one or more particular directions (e.g., height). A particular type of TPMS structure to use as a core or as part of a core plug may be chosen based on mechanical properties of the TPMS structure (e.g., density, Young's modulus, energy absorption, etc.).

TPMS cores of a core structure panel have a uniform density or a density gradient from the first skin to the second skin, from a first end to a second end, or both. FIG. 4 depicts a perspective view of a TPMS structure 400 with a density gradient. Height, width, and length axes are not physically present and so are depicted as broken lines in FIG. 4. Wall thickness of the TPMS structure 400 in a height-width plane increases from a top 402 of the TPMS structure 400 toward a bottom 404 of the TPMS structure 400 to produce the density gradient. In other implementations, wall thickness of a different plane, wall thickness of an additional plane, materials, or combinations thereof, may be adjusted to produce a desired density gradient.

In some implementations, a TPMS core of a core structure panel may include density gradients along a length of the core structure panel. For example, a first portion of a core structure panel may receive little or no load when a force is applied to the core structure panel, while a second portion of the core structure panel is subjected to large load when the force is applied to the core structure panel. Some or all of the first portion may include a low density TPMS core that provides strength to the core structure panel to resist shear forces, bending, buckling, or combinations thereof, that could result due to the force applied to the core structure panel. The low density TPMS core may transition to a higher density TPMS core in the second section that is able to accommodate the large load applied to the second section of the core structure panel when the force is applied to the core structure panel.

TPMS structures are geometrically complex and typical manufacturing processes are not suitable for manufacturing TPMS structures due to geometry restrictions, expense, or both. Additive manufacturing machines are used to produce TPMS structures. If a build plate of an additive manufacturing machine is too small to produce a TPMS structure of a desired size, separately formed TPMS structures can be bonded together, joined together using built-in interlocking features, or both, to form a TPMS structure of the desired size.

Laminate layers may be added to the first skin, the second skin formed by additive manufacturing, or both, of a core structure panel. The additional laminate layers are added to provide particular properties (e.g., strength, stiffness, penetration resistance, water resistance, etc.). For example, one or more aramid layers (e.g., KEVLAR® (a registered trademark of DuPont de Nemours, Inc.)) may be applied to the first skin to increase penetration resistance of the first skin. When the second skin is bonded to the core instead of being produced by additive manufacturing, the second skin may be a laminate including a number of laminate layers so that the second skin has particular properties. For example, the second skin of a particular implementation includes a first carbon fiber reinforced laminate layers with carbon fibers substantially aligned in a first direction relative to the core, a second carbon fiber reinforced laminate layers with carbon fibers substantially aligned in a second direction different than the first direction, an aramid layer, a water barrier layer, one or more additional layers, or combinations thereof.

The core structure panel is sealed to inhibit water or other contaminants from entering the core structure. In some implementations, the first skin is coupled to the second skin to form a seal around one or more sides of the core structure panel, a wall of potting compound or other material is formed between the first skin and the second skin on one or more sides of the core structure panel, a wall is additively manufactured on one or more sides as part of the unit that includes the first skin and the core and is sealed to the second skin, or combinations thereof.

The core structure panel may be formed of metal or a polymer material (e.g., a micro carbon fiber filled nylon, a polyetherimide blend, etc.). In some implementations where the material is a polymer material, the additive manufacturing machine used to form the core structure panel includes multiple nozzles that enable continuous fibers (e.g., carbon fibers, fiberglass, aramid fibers, etc.) to be incorporated in a base polymer material to provide particular properties for the core structure panel. For example, continuous fibers incorporated in the base material of the first skin significantly increase the strength and the stiffness of the first skin.

A technical advantage of the use of additive manufacturing to form at least the first skin and the core allows manufacture of a core structure panel with a simple geometry (e.g., a flat panel), or a complex geometry with a plurality of curved surfaces (e.g., a j-shaped panel) that is difficult to form using typical manufacturing processes that includes a TPMS core. Another technical advantage of the use of additive manufacturing to form at least the first skin and the core is that the surface of the core does not have to be processed to adhere to the bonding material used to couple the first skin to the core since the first skin and the core are formed as a unit. Another technical advantage is that the use of additive manufacturing enables high manufacturing efficiency (e.g., little or no material waste) with a core structure panel having customized properties for an application. The customized properties include cell size, density, density gradient, length, width, height, type of TPMS structure, other properties, or combinations thereof.

A non-destructive test may need to be performed on core structure panels manufactured by attachment of one or both skins to the core to ensure that the skins are appropriately bonded to the core for some core structure panel applications. A technical advantage of the use of additive manufacturing to produce the first skin, core, and second skin as a single piece is that the a core structure panel is ready for use after manufacture without the need to test that the skins are bonded to the core.

A core structure panel may be damaged during use of the core structure panel. Damage of a core structure panel includes one or more openings in one of the skins, one or more openings in both skins, one or more crushed core portions, or combinations thereof. The core can be a TPMS core, a honeycomb core, or other type of core. Aspects disclosed herein present systems and methods for repair of a damaged core structure panel. Particular procedures and specifications for repair of the core structure panel may be detailed in a structural repair manual (SRM) associated with the core structure panel (e.g., a SRM for an aircraft that includes the core structure panel).

An area of a core to be repaired is determined using a nondestructive testing method (e.g., visual inspection, tap testing, ultrasonic inspection, etc.) and a working area that is larger than the area to be repaired is marked on the first skin. The first skin and portions of the core to be repaired are removed in the working area using appropriate tools (e.g., drills, knives, chisels, cutters, grinders, etc.) to form an opening for a core plug.

The opening can have a circular shape, ovoid shape, or other type of shape. The opening can extend into the core structure panel a distance that exceeds a minimum distance (e.g., half an inch) for a partial depth replacement or can extend to the second laminate skin for a full depth replacement. A partial depth replacement may be performed when testing determines that a portion of the core has separated from one of the skins of the core structure panel. When forming the opening, care is taken not to make inconsistencies in the second skin if the opening extends to the second skin. If the second laminate skin already has one or more inconsistencies, or one or more inconsistencies in the second skin are introduced during formation of the opening, the second skin is repaired before repairing the core. The edges of first skin are processed (e.g., sanded) to form a uniform taper around the opening for a subsequent repair of the first skin. In some implementations, moisture in, and adjacent to, the opening is removed using an autoclave or vacuum bag procedure.

An adhesive film is positioned in the opening and a core plug is positioned in the opening on the adhesive film. The core plug includes a triply periodic minimal surface structure surrounded by a foam adhesive. In some implementations, the TPMS structure is generated by an additive manufacturing machine from a material different than the material that forms the core.

The TPMS structure is a sheet based TPMS structure formed using an additive manufacturing machine. Other types of TPMS structures include skeletal based TPMS structures and strut based TPMS structures. In some implementations, the TPMS structure is produced by the additive manufacturing machine to fit in the opening. In other implementations, the TPMS structure is preformed and cut to the size of the opening. The TPMS structure, one or more surfaces of the core structure panel defining the opening, or both, are subjected to a surface treatment to ensure that the TPMS structure is able to bond to the existing core via the foam adhesive and is able to bond to plies above and below the TPMS structure. Bonding of the TPMS structure with the core and the plies above and below the TPMS structure enables loads applied to the core structure panel to be transferred to the TPMS structure. For a TPMS structure formed of a polymer material, the surface treatment may be a plasma treatment (e.g., an atmospheric plasma treatment). For a TPMS structure formed of a metal, the surface treatment may include abrasion, plasma treatment, other treatment, or combinations thereof.

The core structure panel with the core plug positioned in the opening is subjected to a curing process to adhere the TPMS structure of the core plug to the core of the core structure panel via the foam adhesive and to adhere the TPMS structure to the second skin via the adhesive layer. The core structure panel may be placed in an autoclave or subjected to a vacuum bag procedure, during the curing process to draw a vacuum on a portion of the core structure panel, to raise a temperature to a curing temperature, and to remove generated gas.

Subsequent to the curing process, the first skin is repaired by forming a patch for the first skin and curing the patch. The patch includes a filler ply if there is a space between the top of the core plug and a bottom of the first skin, an adhesive film, repair plies that are oriented in directions corresponding to plies of the first skin, one or more additional repair plies, and a nonstructural sanding ply. The core structure panel may be placed in an autoclave, or subjected to a vacuum bag procedure, during curing of the patch.

A technical advantage of using a TPMS structure to repair a core structure panel is that the TPMS structure can have better mechanical properties than the portion of the core being replaced. A TPMS structure can have a high Young's modulus, high impact resistance, and high energy absorption. TPMS structures without a density gradient exhibit isotropic behavior, so the TPMS structures are better able to handle applied stresses from all directions as compared to other structures. Some TPMS structures can be formed with a density gradient to better accommodate stresses and impacts applied from one or more particular directions.

The density gradient for a TPMS structure of a core plug may have a highest density at the laminate skins that decreases towards a center of the TPMS structure, may have a highest density near a laminate skin that is most likely to be subjected to an impact that decreases to the other laminate skin so that the TPMS structure is able to absorb energy of impact against the laminate skin, or may have a different type of density gradient. A material used to form a TPMS structure can have plasticity that provides the TPMS structure with the ability to elastically deform to absorb energy, which can inhibit buckling that can happen to a honeycomb core due to the application of a high axial load.

Use of a TPMS structure for repair of a core structure panel may have additional advantages over use of the same type of core of the core structure panel for repair of the core structure panel. Due to a material of the TPMS structure, due to the shape of a TPMS structure making a labyrinthian path between laminate skins, or both, the TPMS structure may not have the same issues with water ingression as compared to other types of cores. Also, a TPMS structure can advantageously be formed by an additive manufacturing machine to have particular properties (e.g., shape, unit cell size, density gradient, density, etc.) needed for repair of a particular core structure panel.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, the figures and any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. For ease of reference herein, such features are generally introduced as “one or more” features and are subsequently referred to in the singular unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise.

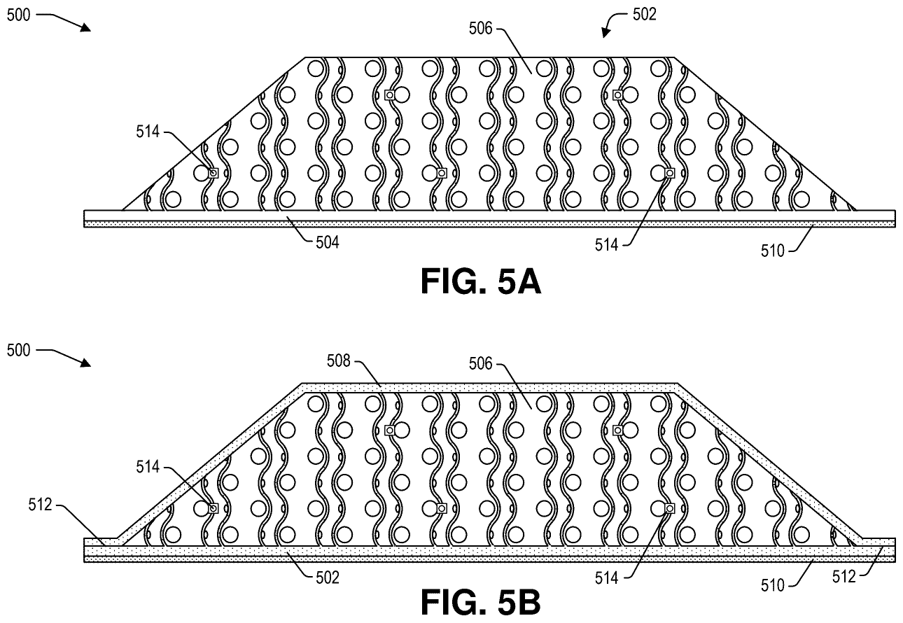

FIG. 5A depicts a cross-sectional representation of a portion of a core structure panel 500 formed as a unit 502 of a first skin 504 and a TPMS core 506 prior to addition of a second skin 508. The first skin 504 and the TPMS core 506 are formed by additive manufacturing as the unit 502. In some implementations, a lamination process is used to add one or more plies 510 to the first skin 504.

FIG. 5B depicts a cross-sectional representation of the portion of the core structure panel 500 with the second skin 508 adhered to the TPMS core 506 and directly to the first skin 504 via adhesive. Adhering the second skin 508 to the first skin 504 forms a seal 512 that inhibits water or other contaminants from entering the TPMS core 506.

In some implementations, the core structure panel 500 has a length, width, or both, that is longer than a build plate of the additive manufacturing machine used to produce the unit of the first skin 504 and the TPMS core 506. To accommodate such core structure panels 500, a number of units 502 including first skins 504 and TPMS cores 506 are produced and the joined together by interlocking features, adhesive, or both. In some implementations, interlocking features are formed on end faces of units that are to be joined together. For example, the TPMS core 506 depicted in FIG. 5A is a first unit 502 that includes a plurality of interlocking features 514 (e.g., male interconnect units having protrusions, female interconnect units having openings, or both) additively manufactured in an exterior face of the TPMS core 506. The interlocking features 514 are configured to be press fit into (or receive) corresponding interlocking features 514 (e.g., corresponding female interconnect units, corresponding male interconnect units) of a second unit (not shown) that is configured to be joined to the first unit 502. Interlocking features 514 other than press fit connections may also be utilized. Alternately, or in addition, the units 502 are bonded together using an adhesive (e.g., a foaming adhesive to enter openings in the TPMS core 506 and securely bind the units 502 together). After the units 502 are joined together, the second skin 508 is coupled (e.g., adhered) to the TPMS core 506 to form the core structure panel 500.

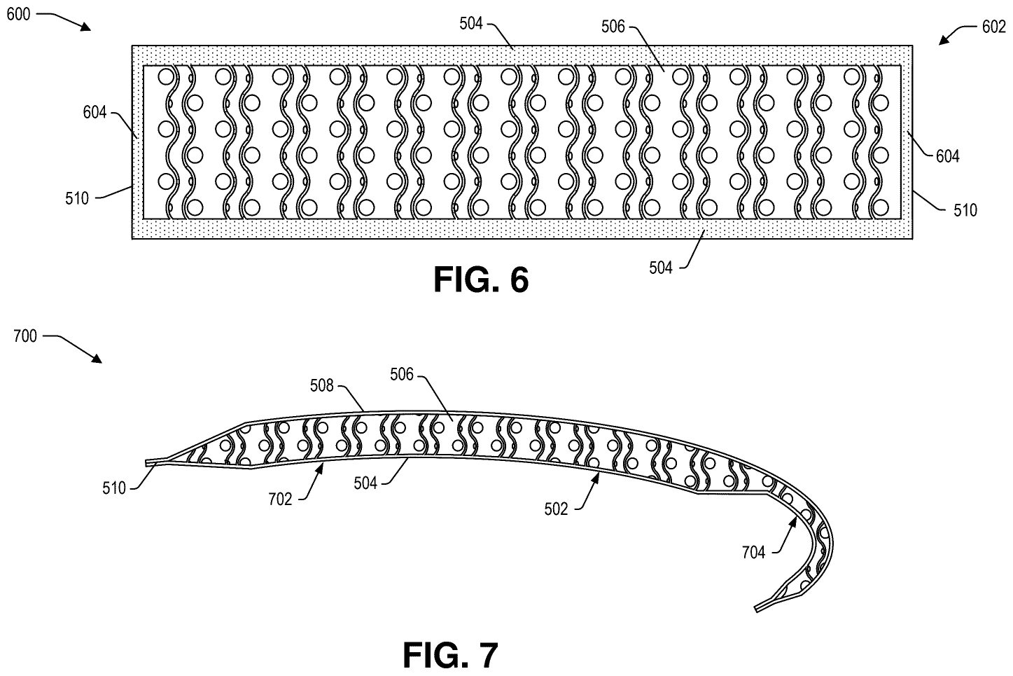

FIG. 6 depicts a cross-sectional representation of a portion of a core structure panel 600 with a first skin 504, a TPMS core 506, and a second skin 508. The first skin 504, the TPMS core 506, and the second skin 508 are formed by additive manufacturing as a unit 602. The core structure panel 600 includes end walls 604 as a seal 512 between the first skin 504 and the second skin 508. The end walls 604 may be formed by additive manufacturing during formation of the unit 602 (e.g., as depicted in FIG. 6), or may be potting compound or other sealant coupled to the first skin 504 and the second skin 508 to form the seal for the TPMS core 506. The seal may contact the TPMS core 506 or may be offset from the TPMS core 506. The seal 512 prevents water or other contaminants from entering the TPMS core 506 through sides of the core structure panel 600. In other implementations, one or more of the sides may be sealed by forming an intersection region of the first skin 504 and the second skin 508. The core structure panel 600 may be the unit 602 formed by additive manufacturing or may be a plurality of units 602 that are coupled together by interlocking features, adhesive, or both, to form the core structure panel 600. Plies may be added to the first skin 504, the second skin 508, or both.

FIG. 7 depicts a side view representation of a portion of a cut open core structure panel 700 with a first skin 504, a TPMS core 506, and a second skin 508. The first skin 504 and the TPMS core 506 are formed by additive manufacturing as the unit 502. The second skin 508 is adhered to the TPMS core 506 and the first skin 504. Adhering the first skin 504 to the second skin 508 forms the seal 512 that inhibits water or other contaminants from entering the TPMS core 506. Other sides of the core structure panel 700 may be sealed with end walls connected to the first skin 504 and the second skin 508, by adhering the first skin 504 directly to the second skin 508, or combinations thereof. In other implementations, the first skin 504, the TPMS core 506, and the second skin 508 are formed by additive manufacturing as a single unit.

The core structure panel 700 of FIG. 7 is a panel with a plurality of curved surfaces. For example, the first skin 504 of the core structure panel 700 of FIG. 7 includes curved surfaces 702 and 704. During additive manufacturing of the unit 502 including the first skin 504 and the TPMS core 506, one or more removable structures may be formed to support portions of the unit 502, and the support structures are removed after completion of additive manufacturing.

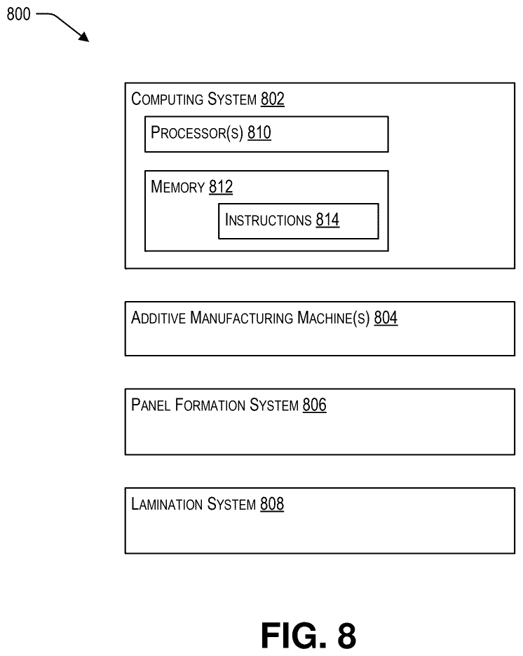

FIG. 8 depicts a block diagram of a representative system 800 to form a core structure panel with a TPMS core. The system 800 includes a computing system 802, one or more additive manufacturing machines 804, a panel formation system 806, a lamination system 808, other systems, or combinations thereof. In other implementations, the system 800 may include additional components or fewer components. For example, the system 800 does not include the panel formation system 806 in implementations where the additive manufacturing machine(s) 804 form the core structure panel as a single unit. As another example, the system 800 does not include the lamination system 808 in implementations where one or more plies are not added to the first skin, the second skin, or both, of the core structure panel.

The computing system 802 includes one or more processors 810 and a memory 812. The memory 812 includes non-transitory computer-readable media. The memory 812 includes instructions 814 executable by the processor(s) 810 to perform operations based on input. The operations may include generating a model of a core structure panel to be formed. Input to the model can specify dimensions, material, and properties of components of the core structure panel to be formed, including the type of TPMS structure to be used as the core of the core structure panel. The model determines estimated properties of the core structure panel based on input data. When personnel determine that the estimated properties of the core structure panel are satisfactory, the model generates one or more data files corresponding to the core structure panel usable by the additive manufacturing machine(s) 804 to generate a unit or units (e.g., when the core structure panel is too big to be formed as one piece by the additive manufacturing machine(s) 804) of the core structure panel. The data file(s) are provided to the additive manufacturing machine(s) 804. In some implementations, the computing system 802 is a component of the additive manufacturing machine(s) 804.

The additive manufacturing machine(s) 804 generate one or more units of the core structure panel based on the data file(s). The unit(s) are formed of metal or polymer material. Personnel test the unit(s) to determine if the unit(s) are satisfactory. If the unit(s) are satisfactory, the additive manufacturing machine(s) 804 are used to produce units. If one or more of the unit(s) are not satisfactory, the computing system 802 is used to adjust the model, or generate a new model, to result in satisfactory units produceable by the additive manufacturing machine(s) 804. In some implementations, a unit includes a first skin and the TPMS core. In other implementations, the unit includes the first skin, the second skin, and the TPMS core. The unit may also include one or more end walls of the core structure panel.

The panel formation system 806 generates the core structure panel from one or more units produced by the additive manufacturing machine(s) 804. For implementations of the core structure panel formed from a plurality of units joined together to form the core structure panel, the panel formation system 806 is configured to join the units together. Joining the units together may include joining interlocking features together, applying and curing adhesive, or both. For example, the first skin of a first unit is abutted against a first skin of a second skin of a second unit. When abutted together, a gap of a size sufficient to allow insertion of a strip of foaming adhesive remains between the TPMS core of the first unit and the TPMS core of the second unit. The lamination system 808 is used to add one or more plies to the first skins to couple the first unit to the second unit, and the strip of foaming adhesive is inserted between the TPMS cores and cured. Excess adhesive is removed and the upper faces of the TPMS cores are surface treated to facilitate adhesion to the second skin. An adhesive is applied to the upper faces, the second skin is applied to the TPMS cores, and the adhesive is cured to couple the second skin to the TPMS cores. In other implementations, a first unit and a second unit are coupled together using a different procedure.

For implementations of the additive manufacturing machine(s) 804 that generate units that include the first skin and the TPMS core, the panel formation system 806 is configured to treat the face of the TPMS core that is to be coupled to the second skin, apply an adhesive to the face, apply the second skin to the TPMS core, and cure the adhesive. A non-destructive test may be performed to determine that the second skin is appropriately bonded to the TPMS core.

The panel formation system 806 is also configured to form a seal for the TPMS core to inhibit entry of water or other contaminants into the TPMS core for unit(s) produced by the additive manufacturing machine(s) without a seal formed by the unit(s). Sealing the TPMS core may include coupling the first skin to the second skin (e.g., directly via an adhesive or indirectly via coupling the first skin to a first end of an end wall and coupling the seconds skin to a second end of the end wall. The end wall may be applied as potting compound or other sealant, or one or both ends of the end wall may be formed by additive manufacturing.

The lamination system adds one or more plies to the first skin, the second skin, or both, of the core structure panel. In an implementation, the lamination system includes a laminator to apply prepreg material to one or both skins of the core structure panel. For core structure panels that include complex curvature, the prepreg material may be applied as tows to conform or substantially conform to curvature of the surfaces. The lamination system also includes curing equipment to cure the prepreg material to form the one or more plies.

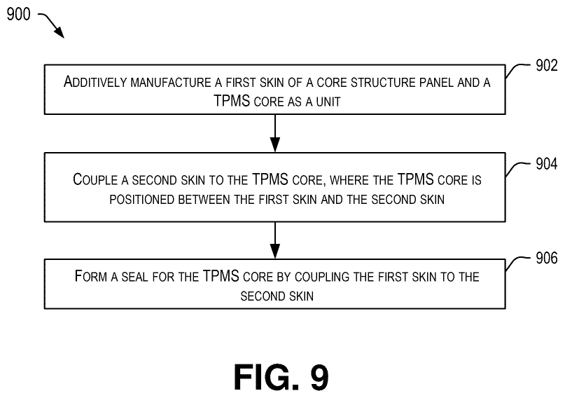

FIG. 9 is a flow chart of an example method 900 for manufacturing a core structure panel having a first skin, a second skin, and a TPMS core positioned between the first skin and the second skin. The core structure panel may be a core structure panel including a first skin, a second skin, and a core with a TPMS structure. The core structure panel includes any of the core structure panels 500, 600, 700 depicted in FIGS. 5-7. The core structure panel is produced using the system 800 of FIG. 8.

The method 900, at block 902, includes additively manufacturing a first skin of a core structure panel and a TPMS core as a unit. For example, the additive manufacturing machine(s) 804 are used to form the unit 502 including the first skin 504 and the TPMS core 506 of the core structure panel 500, 600, or 700.

The method 900, at block 904, includes coupling a second skin to the TPMS core. The TPMS core is positioned between the first skin and the second skin. For example, in an implementation, the second skin 508 is formed by additively manufacturing the second skin 508 on the TPMS core 506 to form the unit 602 of the first skin 504, the second skin 508, and the TPMS core 506, where the TPMS core 506 is positioned between the first skin 504 and the second skin 508.

As another example, in an implementation, portions of a surface of a face of the TPMS core 506 that are to contact the second skin 508 are surface treated to facilitate adhesion of the second skin 508 to the TPMS core 506. The surface treatment may include a plasma treatment for a TPMS core 506 made of a polymer material, and may include abrasion, a plasma treatment, another type of treatment, or combinations thereof, when the TPMS core 506 is made of metal. Adhesive (e.g., a sheet of adhesive) is applied to the TPMS core 506, the second skin 508 is positioned on the adhesive, and the adhesive is cured to couple the second skin 508 to the TPMS core 506.

The method 900, at block 906, also includes forming a seal for the TPMS core by coupling the first skin to the second skin. For example, a portion, or all, of the seal 512 may be formed by adhering the first skin 504 directly to the second skin 508 via adhesive when the second skin 508 is coupled to the TPMS core 506. As another example, a portion, or all, of the seal 512 may be formed by coupling the first skin 504 to the second skin 508 via an end wall 604. In a particular implementation, the end wall 604 is additively manufactured as an extension of the first skin 504 during formation of the unit 502, and the second skin 508 is coupled to the end wall 604 by adhesive when the second skin 508 is coupled to the TPMS core 506. The end wall may be an extension of the TPMS core 506 or may be offset from the TPMS core 506. In another particular implementation, the end wall 604 is additively manufactured as an extension of the first skin 504 during formation of the unit 602, and the second skin 508 is additively manufactured as an extension of the end wall 604 and the TPMS core 506 to form the unit 602. The end wall 604 may be formed as an extension of the TPMS core 506 or may be offset from the TPMS core 506. In another particular implementation, the end wall 604 is formed by coupling potting compound or another type of sealant to the first skin 504 and the second skin 508. The end wall 604 may be offset from the TPMS core 506 or may contact the TPMS core 506.

Core structure panels are sometimes damaged. Impact on the core structure panel can crush a portion of the core, break one or both skins, or combinations thereof. The core of a damaged core structure panel can be a TPMS core, a honeycomb core, or other type of core. In some aspects, a damaged core structure panel is repaired instead of being replaced. When a portion of the core is damaged and needs to be repaired, a TPMS structure can be used to repair the damaged portion of the core.

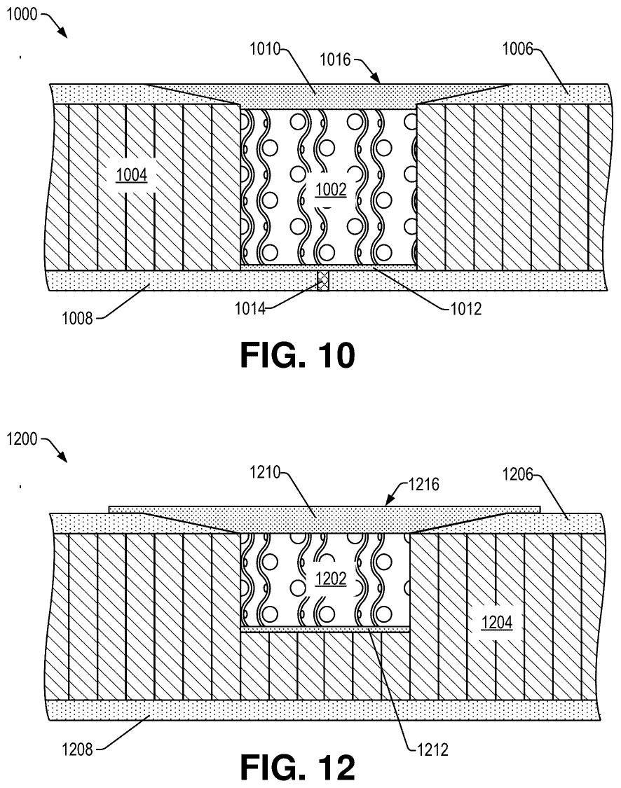

FIG. 10 depicts a cross-sectional representation of a portion of a core structure panel 1000 with a TPMS structure 1002 that is a full depth replacement of a portion of a core 1004 of the core structure panel 1000. The core 1004 may be a honeycomb core as depicted in FIG. 10 or other type of core. The core structure panel 1000 includes the TPMS structure 1002, the core 1004, a first laminate skin 1006, a second laminate skin 1008, a patch 1010, and an adhesive layer 1012 positioned between the TPMS structure 1002 and the second laminate skin 1008.

FIG. 10 also depicts a potted repair 1014 in the second laminate skin 1008. The potted repair 1014 fixes a small opening in the second laminate skin 1008. In an implementation, the potted repair 1014 is an epoxy resin with glass fibers, other fillers, or combinations thereof, that is applied before repair of a portion of the core 1004 of the core structure panel 1000. In some implementations, no repair needs to be made to the second laminate skin 1008. In other implementations, a larger opening in the second laminate skin is repaired with a patch similar to patch 1010 before repair of the core 1004.

The TPMS structure 1002 is positioned in an opening formed in the core structure panel 1000. The opening is formed to remove portions of the core 1004 with one or more inconsistencies and to taper edges of the first laminate skin 1006 to receive the patch 1010. The TPMS structure 1002 is part of a core plug inserted into the opening. The core plug includes the TPMS structure 1002 and a foam adhesive positioned around the TPMS structure 1002. The foam adhesive is activated during a curing process to adhere the TPMS structure 1002 to the core 1004. During the curing process, the TPMS structure 1002 is adhered to the second laminate skin 1008 via the adhesive layer 1012. Subsequent to the curing process, or simultaneously with the curing process, the patch 1010 is formed and cured to repair the first laminate skin 1006. The TPMS structure 1002 and the patch 1010 form a repair patch 1016 for a portion of the core structure panel 1000 with one or more inconsistencies.

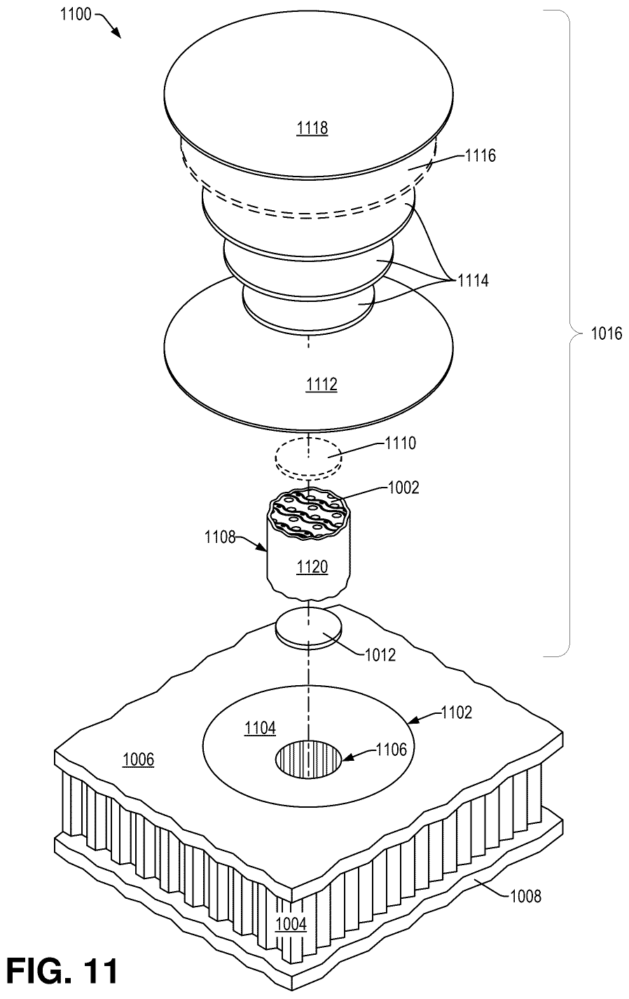

FIG. 11 depicts an exploded view of a system 1100 for repair of a portion of the core structure panel 1000 of FIG. 10 prior to placement of components of the repair patch 1016 used to repair the core structure panel 1000 in, or on, the core structure panel 1000. The core structure panel 1000 includes an opening 1102 with a tapered portion 1104 in the first laminate skin 1006 and a central portion 1106 that extends into the core 1004 a desired depth (e.g., to the second laminate skin 1008 for a full depth repair and to a particular depth for a partial depth repair).

The components of the repair patch 1016 used to repair the core structure panel 1000 include the adhesive layer 1012, a core plug 1108, one or more filler plies 1110, an adhesive film 1112, repair plies 1114, one or more extra repair plies 1116, a nonstructural sanding ply 1118, other layers, or combinations thereof. The core plug 1108 includes the TPMS structure 1002 and a foam adhesive 1120 around the TPMS structure 1002.

The plies 1110, 1114, 1116, 1118 may be prepreg plies. The sanding ply 1118 may be a glass fabric prepreg. The filler ply 1110 and the extra repair ply 1116 are optional and so are depicted in dashed lines in FIG. 11. The filler ply 1110 is used when a top of the TPMS structure positioned in the central portion 1106 of the opening 1102 is below a bottom of the first laminate skin 1006 and the shape of the filler ply 1110 corresponds to a shape of the central portion 1106. The extra repair ply 1116 is used when specified in the structural repair manual associated with the core structure panel 1000. The repair plies 1114 correspond to plies of the first laminate skin 1006 and are oriented as specified in the structural repair manual to correspond to orientation of plies used to form the first laminate skin 1006.

FIG. 12 depicts a cross-sectional representation of a portion of a core structure panel 1200 with a TPMS structure 1202 that is a partial depth replacement of a portion of a core 1204 of the core structure panel 1200. The core 1204 may be a honeycomb core as shown in FIG. 12 or other type of core. The core structure panel 1200 includes the core 1204, a first laminate skin 1206, and a second laminate skin 1208.

Inconsistencies associated with a portion of the core 1204 are repaired with a repair patch 1216, and the repair patch 1216 is a portion of the core structure panel 1200. The repair patch 1216 includes an adhesive layer 1212 positioned between the TPMS structure 1202 and the core 1204, the TPMS structure 1202, and a patch 1210. A bottom surface of the TPMS structure 1202 is adhered to the core 1204 via the adhesive layer 1212 and a foam adhesive around one or more side surfaces of the TPMS structure 1202 also adhere the TPMS structure 1202 to the core 1204. The patch 1210 is adhered to a top surface of the TPMS structure 1202 and the first laminate skin 1206. The patch is formed of an adhesive film; repair plies that correspond to, and are oriented in the same directions as, plies that form the first laminate skin 1206; one or more extra repair plies adhered to the first laminate skin 1206 via the adhesive film and adhered to an upper repair ply of the repair plies; and a sanding ply. The sanding ply may be removed or substantially removed by sanding during a finishing process of forming the repair patch 1216. In an implementation, a first curing process is used to adhere the TPMS structure 1202 to the core 1204 via the adhesive layer 1212 and an adhesive foam around the TPMS structure 1202, and a second curing process is used to adhere the components of the patch 1210 to the TPMS structure 1202 and to the first laminate skin 1206.

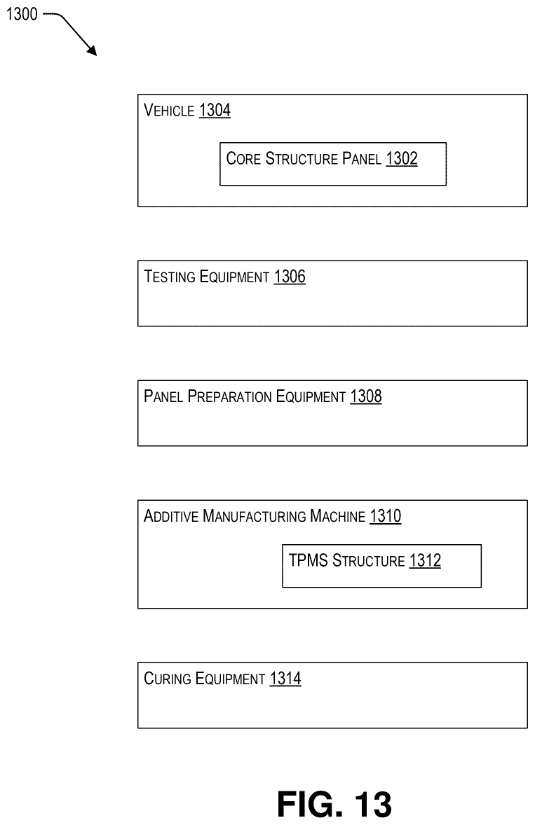

FIG. 13 depicts a block diagram of a system 1300 to repair a core structure panel 1302 (e.g., the core structure panel 1000 of FIG. 10 or the core structure panel 1200 of FIG. 12). The core structure panel 1302 may be a portion of a vehicle 1304 (e.g., an aircraft, automobile, watercraft, or combination thereof) or a core structure panel used in a different application. In some implementations, the core structure panel 1302 may be a portion of an outer surface of the vehicle 1304. In some implementations, the core structure panel 1302 is removed from the vehicle before being repaired, and in other implementations, the core structure panel 1302 is repaired while remaining attached to the vehicle 1304. During a lifetime of the vehicle 1304, the core structure panel 1302 may be subject to one or more events that could cause inconsistencies in the core structure panel 1302.

When the core structure panel 1302 is suspected to have one or more inconsistencies (e.g., due to impact, a lightning strike, suspected water ingress, etc.), a visual inspection, testing equipment 1306, or both, may be used to determine whether the core structure panel 1302 has one or more inconsistencies and whether the one or more inconsistencies includes one or more inconsistencies associated with a core of the core structure panel 1302. The testing equipment may include tap instruments used by an inspector to detect for inconsistencies based on sound changes in different areas of the core structure panel 1302, ultrasound devices, moisture detectors, and other non-invasive testing devices. When the core structure panel 1302 has one or more inconsistencies, a working area that defines an extent of the core structure panel 1302 with one or more inconsistencies may be marked on a skin of the core structure panel 1302.

Panel preparation equipment 1308 is used to prepare the core structure panel 1302 for repair. The panel preparation equipment may include one or more knives, grinders, shears, sanders, cleaning tools (e.g., a vacuum to remove small cuttings, a plasma device for atmospheric plasma treatment of surfaces, cleaning fluids, etc.), and other tools to form an opening in the core structure panel 1302 through a skin of the core structure panel 1302, to remove core material with one or more inconsistencies, and to prepare surfaces for repairing the core structure panel 1302.

The system 1300 includes an additive manufacturing machine 1310 to generate a TPMS structure 1312 used as a core repair. In some implementations, the additive manufacturing machine generates the TPMS structure 1312 based on dimensions of the opening formed in the core structure panel 1302. In other implementations, the TPMS structure 1312 is cut from a sheet of pre-formed TPMS structure formed by the additive manufacturing machine 1310.

The system 1300 also includes curing equipment 1314 to cure (e.g., chemically react) portions of a repair patch to repair the one or more inconsistencies of the core structure panel 1302. The curing equipment 1314 may also be used to apply heat, a vacuum, or both, to remove moisture from a treatment area of the core structure panel 1302 to be repaired before a core plug including the TPMS structure 1312 that replaces portions of the core with one or more inconsistencies is positioned in the core structure panel 1302. The curing equipment 1314 may be an autoclave for smaller core structure panels 1302. For large core structure panels 1302 and for repairs performed on vehicles 1304 that will not fit in available autoclaves, vacuum bag procedures are utilized to apply heat, vacuum, or both to treatment areas. A vacuum bag procedure may utilize one or more thermocouples, breather cloths, one or more heat blankets, pressure gauges, an interface to a treatment area, and bag material sealed to the interface and the core structure panels 1302 to allow vacuum and heat to be applied to the treatment area.

In addition to testing the core structure panel 1302 to determine portions of the core structure panel 1302 with one or more inconsistencies, the testing equipment 1306 is used for post repair inspection. Visual inspection, tap inspection, ultrasonic inspection, other types of non-destructive inspection, or combinations thereof, may be performed to ensure that the repair patch is satisfactory. In addition, for some implementations, one or more additional tests performable using the testing equipment 1306 (e.g., a balance check) are performed to ensure that the patch repair is within specifications provided in the structural repair manual associated with the core structure panel 1302.

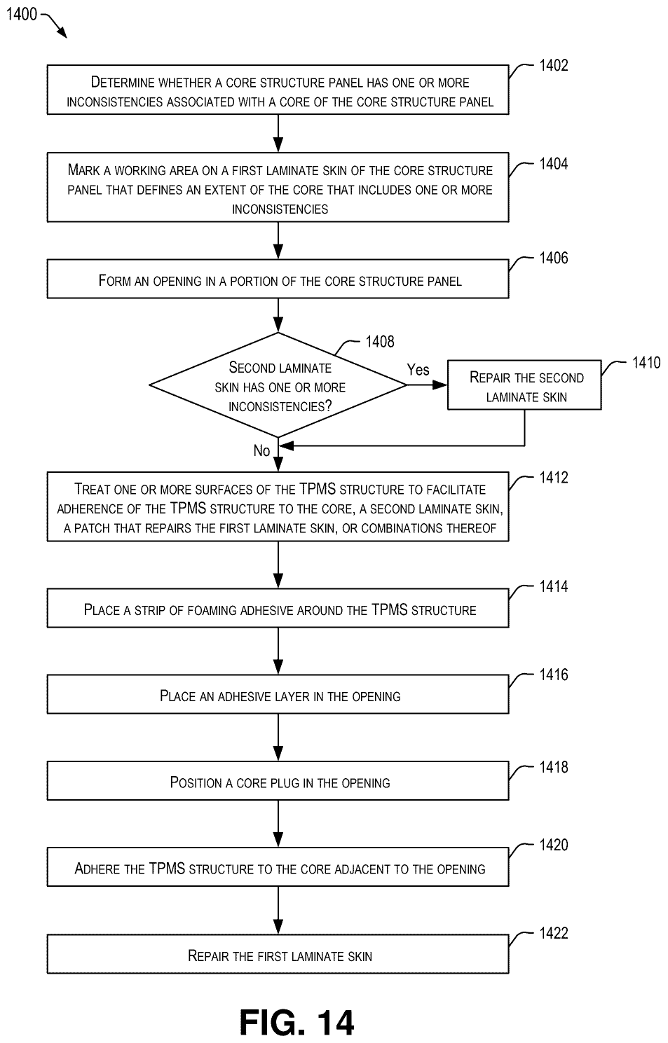

FIG. 14 is a flow chart of an example method 1400 for repairing a core structure panel with a repair patch. The core structure panel may be the core structure panel 1000 depicted in FIG. 10 and FIG. 11, or the core structure panel 1200 depicted in FIG. 12. The repair patch may be the repair patch 1016 depicted in FIG. 10 and FIG. 11, or the repair patch 1216 depicted in FIG. 12. The method may be performed using the system 1300 depicted in FIG. 13. The method 1400, at block 1402, includes determining whether a core structure panel has one or more inconsistencies associated with a core of the core structure panel. For example, a visual inspection, testing performed using the testing equipment 1306, or both, are used to determine if the core structure panel 1000, 1200 has one or more inconsistencies. If both laminate skins 1006, 1008, include openings to the core 1004, the opening in the laminate skin 1008 is repaired. For example, the core structure panel 1000 of FIG. 10 included openings to the core 1004 in both laminate skins 1006, 1008, and the opening in the second laminate skin 1008 was repaired with the potted repair 1014.

The method 1400, at block 1404, includes marking a working area on a first laminate skin of the core structure panel that defines an extent of the core that includes one or more inconsistencies. For example, the working area is marked on the first laminate skin 1006, 1206. The working area includes all portions of the core 1004, 1204 with the one or more inconsistencies and can include portions of the core 1004, 1204 surrounding the portions with one or more inconsistencies to ensure that all portions of the core with inconsistencies are repaired.

The method 1400, at block 1406, includes forming an opening in the core structure panel, where the opening extends through the first laminate skin and at least partially through the core. For example, formation of the opening (e.g., the opening 1102 of FIG. 6) removes portions of the core structure panel 1000, 1200 with one or more inconsistencies, including portions of the first laminate skin 1006, 1206 with one or more inconsistencies, and portions of the core 1004, 1204 with one or more inconsistencies. Formation of the opening 1102 removes a portion of the core 1004 in the working area. In an implementation, the opening 1102 includes the tapered portion 1104 in the first laminate skin 1006, 1206 and the central portion 1106 that extends into the core 1004, 1204. The central portion 1106 can extend to the second laminate skin 1008 when the repair is a full depth repair, as depicted in FIG. 10, or the central portion 1106 can extend a particular depth into the core 1204 beyond a minimal depth when the repair is a partial depth repair, as in FIG. 12. Debris in the opening 1102 is removed and the surfaces that define the central portion 1106 can be cleaned, surface treated, or both, to facilitate adherence with a core plug 1108 positioned in the central portion 1106.

The method 1400, at decision block 1408, includes determining if the second laminate skin has one or more inconsistencies. If the second laminate skin has one or more inconsistencies, the method 1400, at block 1410, includes repairing the second laminate skin. For example, a repair of the second laminate skin 1008 may be a potted repair 1014 for small sized inconsistencies in the second laminate skin 1008, 1208 (e.g., inconsistencies with lengths less than a half an inch) or a patch for more extensive inconsistencies in the second laminate skin 1008.

After block 1410 or when the decision block 1408 indicates the second skin has no inconsistencies, the method 1400, at block 1412, includes treating one or more surfaces of a TPMS structure. Treating one or more surfaces of the TPMS structure facilitates adherence of the TPMS structure to the core, a second laminate skin, a patch that repairs the first laminate skin, or combinations thereof. For example, outmost surfaces of the TPMS structure 1002, 1202 are treated. The TPMS structure 1002, 1202 replaces portions of the core 1004, 1204 removed during formation of the opening 1102. The TPMS structure 1002, 1202 may be formed by the additive manufacturing machine 1310. When the TPMS structure 1002, 1202 is made from a polymer material, treatment of the surface may include exposing the surface to plasma (e.g., atmospheric plasma) via a nozzle of a cleaning tool of the preparation equipment 1308 to clean and activate the surface (e.g., convert a low energy surface to a higher energy surface by attaching polar molecules to the surface). When the TPMS structure 1002, 1202 is formed of metal, treatment of the metal may include abrasion, exposing the surface to plasma (e.g., atmospheric plasma), other treatment, or combinations thereof.

The method 1400, at block 1414, includes placing a strip of foaming adhesive around the TPMS structure to form a core plug. For example, foaming adhesive 1120 is placed around the TPMS structure 1002, 1202. The foaming adhesive 1120 enables the TPMS structure 1002 to adhere to the core 1004, 1204 of the core structure panel 1000, 1200.

The method 1400, at block 1416, includes placing an adhesive layer in the central portion of the opening. For example, the adhesive layer 1012, 1212 of FIG. 11 is positioned the central portion 1106 of the opening 1102. The adhesive layer 1012, 1212 enables a bottom of the core plug 1108 to adhere to the second laminate skin 1008 when the repair is a full depth repair or enables the bottom of the core plug 1108 to adhere to the core 1204 when the repair is a partial depth repair.

The method 1400, at block 1418, includes positioning the core plug in the opening. For example, the core plug 1108 of FIG. 11 is placed in the opening 1102.

The method 1400, at block 1420, includes adhering the TPMS structure to the core adjacent to the opening. For example, a curing process is implemented to adhere the TPMS structure 1002, 1202 to the core 1004 via the foam adhesive 1120 and to adhere the bottom of the TPMS structure 1002, 1202 to the second laminate skin 1008 via the adhesive layer 1012 for a full depth repair or to the core 1204 via the adhesive layer 1212 for a partial depth repair. The curing process is implemented using the curing equipment 1314 to draw a vacuum and heat the foam adhesive 1120 and the adhesive layer 1012, 1212 to a curing temperature.

The method 1400, at block 1422, also includes repairing the first laminate skin. For example, repairing the first laminate skin 1006, 1206 includes placing a filler ply 1110 on top of the TPMS structure 1002, 1202 if a top of the TPMS structure 1002, 1202 is below a bottom of the first laminate skin 1006, 1206. If the top of the TPMS structure 1002, 1202 is above the bottom of the first laminate skin 1006, 1206, the top of the TPMS structure 1002, 1202 is ground down to be at the height of the bottom of the first laminate skin 1006, 1206. An adhesive film 1112 is positioned to cover the remaining portions of the opening 1102 and a portion of the first laminate skin 1006, 1206 surrounding the opening 1102. Plies 1114, 1116, 1118 are positioned on the adhesive film 1112. A curing process is implemented to cure the adhesive film 1112 and the plies 1110, 1114, 1116, 1118 to form the patch 1010, 1210 that adheres to the TPMS structure 1002, 1202 and the first laminate skin 1006, 1206. After the curing process, a finishing process is implemented to provide appropriate surface characteristics to the patch 1010, 1210, and the testing equipment 1306 can be used to determine that the repair of the core structure panel 1000, 1200 is a satisfactory repair.

Although the method 1400 is illustrated as including a certain number of steps, more, fewer, and/or different steps can be included in the method 1400 without departing from the scope of the subject disclosure. For example, the decision block 1408 can be performed before forming the opening 1102 when the repair is a partial depth repair, and before and after forming the opening 1102 when the repair is a full depth repair.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. As a further example, the drawings are conceptual and are not drawn to scale. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter can be directed to less than all of the features of any of the disclosed examples. Accordingly, the scope of the disclosure is defined by the following claims and their equivalents.

Further, the disclosure comprises embodiments according to the following Examples:

According to Example 1, a core structure panel includes a first skin and a TPMS core additively manufactured as a unit; and a second skin coupled to the TPMS core, wherein the TPMS core is positioned between the first skin and the second skin.

Example 2 includes the core structure panel of Example 1, wherein the second skin is adhered to the TPMS core.

Example 3 includes the core structure panel of Example 1 or Example 2, further comprising a seal around the TPMS core, wherein the seal couples the first skin to the second skin.

Example 4 includes the core structure panel of Example3, wherein the seal comprises potting compound, an end wall additively manufactured on the first skin and coupled to the second skin, or both.

Example 5 includes the core structure panel of any of Examples 1 to 4 and further includes one or more plies coupled to the first skin, the second skin, or both.

Example 6 includes the core structure panel of any of Examples 1 to 5, wherein the core structure panel comprises a plurality of units coupled together by interlocking features of TPMS cores of the plurality of units.

Example 7 includes the core structure panel of Example 6, wherein a first particular unit of the plurality of units includes a plurality of protrusions, wherein a second particular unit of the plurality of units includes a corresponding plurality of openings, and wherein the interlocking features between the first particular unit and the second particular unit are press fit connections of the plurality of protrusions in the corresponding plurality of openings.

Example 8 includes the core structure panel of any of Examples 1 to 7, wherein the TPMS core has a density gradient between the first skin and the second skin.

Example 9 includes the core structure panel of Example 8, wherein the TPMS core has a first density near the first skin that decreases to a second density near the second skin.

Example 10 includes the core structure panel of Example 8, wherein the TPMS core has a first density near the first skin that decreases to a second density at a first position between the first skin and the second skin, and wherein the TPMS has a third density near the second skin that decreases to the second density at the first position

According to Example 11, a core structure panel includes a first skin, a second skin, and a triply periodic minimal surface (TPMS) core additively manufactured as a unit, wherein the TPMS core is positioned between the first skin and the second skin.

Example 12 includes the core structure panel of Example 11, wherein the first skin, the second skin, and the TPMS core comprise metal or a polymer material.

Example 13 includes the core structure panel of Example 11 or Example 12, wherein the first skin includes one or more curved surfaces.

According to Example 14, a method includes additively manufacturing a first skin of a core structure panel and a triply periodic minimal surface (TPMS) core as a unit; and coupling a second skin to the TPMS core, wherein the TPMS core is positioned between the first skin and the second skin.

Example 15 includes the method of Example 14, wherein said coupling the second skin to the TPMS core comprises forming the second skin by additively manufacturing the second skin on the TPMS core.

Example 16 includes the method of Example 14, wherein said coupling the second skin to the TPMS core comprises adhering the second skin to the TPMS core.

Example 17 includes the method of claim 14, and further includes forming a seal for the TPMS core by coupling the first skin to the second skin.

Example 18 includes the method of Example 17, wherein the first skin is directly coupled to the second skin by adhesive to form the seal.

Example 19 includes the method of any of Examples 14 to 18, wherein the TPMS core has one or more density gradients between the first skin and the second skin.

Example 20 includes the method of any of Examples 14 to 19, wherein the TPMS core includes one or more density gradients along a length of the TPMS core.

What is claimed is:

1. A core structure panel comprising:
a first skin and a triply periodic minimal surface (TPMS) core additively manufactured as a unit; and
a second skin coupled to the TPMS core, wherein the TPMS core is positioned between the first skin and the second skin.

2. The core structure panel of claim 1, wherein the second skin is adhered to the TPMS core.

3. The core structure panel of claim 1, further comprising a seal around the TPMS core, wherein the seal couples the first skin to the second skin.

4. The core structure panel of claim 3, wherein the seal comprises potting compound, an end wall additively manufactured on the first skin and coupled to the second skin, or both.

5. The core structure panel of claim 1, further comprising one or more plies coupled to the first skin, the second skin, or both.

6. The core structure panel of claim 1, wherein the core structure panel comprises a plurality of units coupled together by interlocking features of corresponding TPMS cores of the plurality of units.

7. The core structure panel of claim 6, wherein a first particular unit of the plurality of units includes a plurality of protrusions, wherein a second particular unit of the plurality of units includes a corresponding plurality of openings, and wherein the interlocking features between the first particular unit and the second particular unit are press fit connections of the plurality of protrusions in the corresponding plurality of openings.

8. The core structure panel of claim 1, wherein the TPMS core has a density gradient between the first skin and the second skin.

9. The core structure panel of claim 8, wherein the TPMS core has a first density near the first skin that decreases to a second density near the second skin.

10. The core structure panel of claim 8, wherein the TPMS core has a first density near the first skin that decreases to a second density at a first position between the first skin and the second skin, and wherein the TPMS has a third density near the second skin that decreases to the second density at the first position.

11. A core structure panel comprising:
a first skin, a second skin, and a triply periodic minimal surface (TPMS) core additively manufactured as a unit, wherein the TPMS core is positioned between the first skin and the second skin.

12. The core structure panel of claim 11, wherein the first skin, the second skin, and the TPMS core comprise metal or a polymer material.

13. The core structure panel of claim 11, wherein the first skin includes one or more curved surfaces.

14. A method comprising:
additively manufacturing a first skin of a core structure panel and a triply periodic minimal surface (TPMS) core as a unit; and
coupling a second skin to the TPMS core, wherein the TPMS core is positioned between the first skin and the second skin.

15. The method of claim 14, wherein said coupling the second skin to the TPMS core comprises forming the second skin by additively manufacturing the second skin on the TPMS core.

16. The method of claim 14, wherein said coupling the second skin to the TPMS core comprises adhering the second skin to the TPMS core.

17. The method of claim 14, further comprising forming a seal for the TPMS core by coupling the first skin to the second skin.

18. The method of claim 17, wherein the first skin is coupled to the second skin to form the seal.

19. The method of claim 14, wherein the TPMS core has one or more density gradients between the first skin and the second skin.

20. The method of claim 14, wherein the TPMS core includes one or more density gradients along a length of the TPMS core.
